(19) United States
(12) Patent Application Publication
(10) Pub. No.: US 2020/0148212 A1
(43) Pub. Date: May 14, 2020

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventor: Takayuki Kishi, Wako-shi (JP)

(21) Appl. No.: 16/672,627

(22) Filed: Nov. 4, 2019

(30) Foreign Application Priority Data
Nov. 14, 2018 (JP) 2018-213602

(51) Int. Cl. B60W 30/18

(52) U.S. Cl. CPC B60W 30/18172; B60W 2520/10; B60W 2520/26; B60W 2520/28

(57) ABSTRACT

A vehicle control device including a first driving force controller and a second driving force controller. The first driving force controller executes the first driving force control or the second driving force controller executes the second driving force control, on the basis of the speed of the vehicle, the first vehicle speed limit, and the second vehicle speed limit. The first vehicle speed limit and the second vehicle speed limit change independently of each other.

### CROSS-REFERENCE TO RELATED APPLICATION

Priority is claimed on Japanese Patent Application No. 2018-213602, filed Nov. 14, 2018, the content of which is incorporated herein by reference.

### BACKGROUND

### Field of the Invention

The present invention relates to a vehicle control device, a vehicle control method, and a storage medium.

### Description of Related Art

Conventionally, a device for performing braking of one drive wheel in preference to engine output control when slipping occurs because a rotation difference between left and right drive wheels is greater than or equal to a prescribed value and a device for reducing slipping of a drive wheel by reducing the torque applied to the drive wheel on the basis of a rotation difference between the drive wheel and a non-drive wheel have been disclosed (Japanese Unexamined Patent Application, First Publication Nos. 62-203863 and 59-202963).

### SUMMARY

However, a case in which interference due to other control is present or control is switched is not taken into account in the above-described technology.

Aspects of the present invention have been made in consideration of such circumstances and an objective of the present invention is to provide to a vehicle control device, a vehicle control method, and a storage medium capable of controlling a vehicle more accurately in various scenes.

A vehicle control device, a vehicle control method, and a storage medium according to the present invention adopt the following configurations.

(1): According to an aspect of the present invention, there is provided a vehicle control device including: a first driving force controller configured to execute first driving force control, the first driving force control including calculating a first vehicle speed limit on the basis of a rotation difference between left and right wheels of a vehicle, and calculating a first upper-limit driving force as a target driving force according to a speed of the vehicle when the speed of the vehicle exceeds the first vehicle speed limit; and a second driving force controller configured to execute second driving force control, the second driving force control including calculating a second vehicle speed limit on the basis of a rotation difference between front and rear wheels of the vehicle and calculating a second upper-limit driving force as a target driving force according to a speed of the vehicle when the speed of the vehicle exceeds the second vehicle speed limit, the first driving force controller executes the first driving force control or the second driving force controller executes the second driving force control, on the basis of the speed of the vehicle, the first vehicle speed limit, and the second vehicle speed limit, and the first vehicle speed limit and the second vehicle speed limit change independently of each other.

(2): In the above-described aspect (1), wherein, when the speed of the vehicle exceeds a lower one of the first vehicle speed limit and the second vehicle speed limit, the speed of the vehicle does not exceeds a higher one of the first vehicle speed limit and the second vehicle speed limit, and the lower one is the first vehicle speed limit, the first driving force controller executes the first driving force control, when the speed of the vehicle exceeds the lower one, the speed of the vehicle does not exceeds the higher one, and the lower one is the second vehicle speed limit, the second driving force controller executes the second driving force control, when the speed of the vehicle exceeds both of the first vehicle speed limit and the second vehicle speed limit and the first upper-limit driving force is smaller than the second upper-limit driving force, the first driving force controller executes the first driving force control, when the speed of the vehicle exceeds both of the first vehicle speed limit and the second vehicle speed limit and the second upper-limit driving force is smaller than the first upper-limit driving force, the second driving force controller executes the second driving force control.

(3): In the above-described aspect (1), the first driving force controller executes a first integration process of integrating differences between the first vehicle speed limit and the speed of the vehicle and calculates the first upper-limit driving force by using an integrated value that has been integrated, the second driving force controller executes a second integration process of integrating differences between the second vehicle speed limit and the speed of the vehicle and calculates the second upper-limit driving force by using an integrated value that has been integrated, when the speed of the vehicle exceeds a lower one of the first vehicle speed limit and the second vehicle speed limit, the speed of the vehicle does not exceeds a higher one of the first vehicle speed limit and the second vehicle speed limit, and the lower one is the first vehicle speed limit, the first driving force controller executes the first driving force control, and the second driving force controller stops the second driving force control and reset the integrated value, when the speed of the vehicle exceeds the lower one, the speed of the vehicle does not exceeds the higher one, and the lower one is the second vehicle speed limit, the second driving force controller executes the second driving force control, and the first driving force controller stops the first driving force control and reset the integrated value, when the speed of the vehicle exceeds both of the first vehicle speed limit and the second vehicle speed limit and the first upper-limit driving force is smaller than the second upper-limit driving force, the first driving force controller executes the first driving force control, the first driving force controller continues the first integration process, and the second driving force controller continues the second integration process, when the speed of the vehicle exceeds both of the first vehicle speed limit and the second vehicle speed limit and the second upper-limit driving force is smaller than the first upper-limit driving force, the second driving force controller executes the second driving force control, the first driving force controller continues the first integration process, and the second driving force controller continues the second integration process.

(4): In the above-described aspect (1), the second driving force controller sets an initial value of a target driving force of the second driving force control to a target driving force of the first driving force control, when the first driving force control is switched to the second driving force control and a driving force of the first driving force control is different from the target driving force of the second driving force control.

(5): In the above-described aspect (1), the first driving force controller sets an initial value of a target driving force of the first driving force control to a target driving force of the second driving force control, when the second driving force control is switched to the first driving force control and a driving force of the second driving force control is different from the target driving force of the first driving force control.

(6): According to an aspect of the present invention, there is provided a vehicle control method including: executing first driving force control, the first driving force control including calculating a first vehicle speed limit on the basis of a rotation difference between left and right wheels of a vehicle and calculating an upper-limit driving force as a target driving force according to a speed of the vehicle when the speed of the vehicle exceeds the first vehicle speed limit; executing second driving force control, the second driving force control including calculating a second vehicle speed limit on the basis of a rotation difference between front and rear wheels of the vehicle and calculating an upper-limit driving force as a target driving force according to a speed of the vehicle when the speed of the vehicle exceeds the second vehicle speed limit; and executing either the first driving force control or the second driving force control on the basis of the speed of the vehicle, the first vehicle speed limit, and the second vehicle speed limit, wherein the first vehicle speed limit and the second vehicle speed limit change independently of each other.

(7): According to an aspect of the present invention, there is provided a computer-readable non-transitory storage medium storing a program for causing a control device to: execute first driving force control, the first driving force control including calculating a first vehicle speed limit on the basis of a rotation difference between left and right wheels of a vehicle and calculating an upper-limit driving force as a target driving force according to a speed of the vehicle when the speed of the vehicle exceeds the first vehicle speed limit; execute second driving force control, the second driving force control including calculating a second vehicle speed limit on the basis of a rotation difference between front and rear wheels of the vehicle and calculating an upper-limit driving force as a target driving force according to a speed of the vehicle when the speed of the vehicle exceeds the second vehicle speed limit; and execute either the first driving force control or the second driving force control on the basis of the speed of the vehicle, the first vehicle speed limit, and the second vehicle speed limit, wherein the first vehicle speed limit and the second vehicle speed limit change independently of each other.

According to the above-described aspects (1) to (7), the vehicle control device can control a vehicle more accurately in various scenes by causing either first driving force control or second driving force control to be executed on the basis of a speed of the vehicle, a first vehicle speed limit, and a second vehicle speed limit.

According to the above-described aspect (2), the vehicle control device can perform driving force control effective for slipping prevention by providing a threshold value which changes on the basis of a rotation difference between wheels and mutually performing switching between two types of driving force control differing in accordance with a travel situation.

According to the above-described aspect (3), it is possible to update a maximum driving force for protecting a differential without causing slipping. For example, it is possible to minimize a rapid increase in an upper-limit driving force by resetting the integration of an I term (an integral term) in a controller which is not in operation when an operation of one type of control is in an ON state and by setting an initial value of the I term so that the upper-limit driving force is transferred for switching even when control is switched. For example, both controllers can cause a process of integrating values of the I term to be continued when both operations are in an ON state and can cause an appropriate upper-limit driving force to be transferred in the case of switching to driving force control which is not being executed by setting an initial value of the I term so that the upper-limit driving force is transferred.

According to the above-described (4) or (5), the vehicle control device controls a driving force so that a gap in driving force is not generated in the case of switching from one type of control to the other type of control, thereby preventing an occupant of a vehicle from feeling unease and executing appropriate driving force control so that excess or deficiency in a driving force is not caused.

### BRIEF DESCRIPTION OF THE DRAWINGS

FIG. 1 is a diagram showing an example of a functional configuration of a vehicle system including a vehicle control device.

FIG. 2 is an explanatory diagram showing the control of a first controller.

FIG. 3 is an explanatory diagram showing the control of a second controller.

FIG. 4 is an explanatory diagram (part 1) showing details of a process of an integrated controller.

FIG. 5 is a diagram showing a summary of states and the like in periods T1 to T5 shown in FIG. 4.

FIG. 6 is a diagram showing an example of a process to be performed when second control is in an ON state.

FIG. 7 is a diagram showing an example of a process to be performed when the first control and second control are in an ON state.

FIG. 8 is an explanatory diagram showing the transfer of a driving force.

FIG. 9 is a diagram showing an example of a process in which the first controller of a transfer destination calculates a driving force.

FIG. 10 is a diagram showing an example of details of control by a device of a comparative example.

FIG. 11 is a diagram showing an example of a hardware configuration of the control device of an embodiment.

### DESCRIPTION OF EMBODIMENTS

Embodiments of a vehicle control device, a vehicle control method, and a storage medium of the present invention will be described below with reference to the drawings.

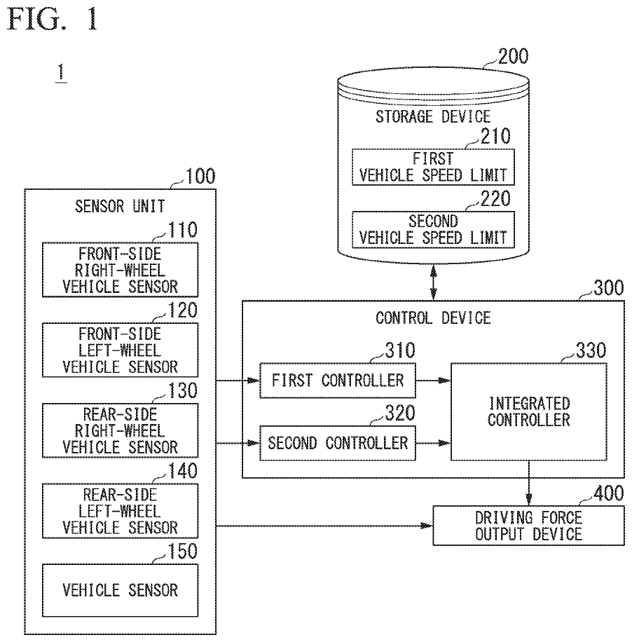

FIG. 1 is a diagram showing an example of a functional configuration of a vehicle system 1 including a vehicle control device. For example, the vehicle system 1 is mounted on a four-wheeled vehicle or the like. A driving source of the vehicle is an internal combustion engine such as a diesel engine or a gasoline engine, an electric motor, or a combination thereof. The vehicle may be, for example, a front-wheel drive vehicle or a rear-wheel drive vehicle in which a rotating force generated by the driving source is distributed to front or rear wheels or a four-wheel drive vehicle in which a rotating force generated by the driving source is distributed to front and rear wheels. The vehicle may be a full-time four-wheel drive vehicle or a part-time four-wheel drive vehicle.

The vehicle system 1 includes, for example, a sensor unit 100, a storage device 200, a control device 300, and a driving force output device 400.

### [Sensor Unit]

The sensor unit 100 includes, for example, a front-side right-wheel speed sensor 110, a front-side left-wheel speed sensor 120, a rear-side right-wheel speed sensor 130, a rear-side left-wheel speed sensor 140, and a vehicle sensor 150.

For example, the front-side right-wheel speed sensor 110 is attached to the right wheel on the front side of the vehicle and detects a speed of the right wheel on the basis of a rotation speed of the right wheel on the front side. For example, the front-side left-wheel speed sensor 120 is attached to the left wheel of the vehicle and detects a speed of the left wheel on the basis of a rotation speed of the left wheel on the front side.

For example, the rear-side right-wheel speed sensor 130 is attached to the right wheel on the rear side of the vehicle and detects a speed of the right wheel on the basis of a rotation speed of the right wheel on the rear side. For example, the rear-side left-wheel speed sensor 140 is attached to the left wheel on the rear side of the vehicle and detects a speed of the left wheel on the basis of a rotation speed of the left wheel on the rear side.

The vehicle sensor 150 is a speed sensor configured to detect a speed of the vehicle body, a biaxial or triaxial acceleration sensor configured to detect acceleration, a direction sensor configured to detect a direction of the vehicle, an inclination sensor configured to detect an inclination of a road on which the vehicle is traveling, and the like. The vehicle sensor 150 may include a steering angle sensor, a yaw rate sensor, and the like. The steering angle sensor is provided on a steering shaft and detects a rotation angle of the steering shaft. The yaw rate sensor detects an angular speed around a vertical axis.

### [Storage Device]

For example, the storage device 200 is implemented by an HDD, a flash memory, an electrically erasable programmable read only memory (EEPROM), a read only memory (ROM), a random access memory (RAM), or the like. The storage device 200 stores a left/right difference vehicle speed limit and a front/rear difference vehicle speed limit which are information indicating vehicle speed limits of wheels (a first vehicle speed limit 210 and a second vehicle speed limit 220 in FIG. 1) or base information for calculating the vehicle speed limits. Details of the vehicle speed limits will be described below.

### [Control Device]

For example, the control device 300 includes a first controller 310, a second controller 320, and an integrated controller 330. Each of the first controller 310, the second controller 320, and the integrated controller 330 is implemented, for example, by a hardware processor such as a central processing unit (CPU) executing a program (software). Some or all of these components are implemented, for example, by hardware (a circuit unit including circuitry) such as large scale integration (LSI), an application specific integrated circuit (ASIC), a field-programmable gate array (FPGA), or a graphics processing unit (GPU) or may be implemented by cooperation between software and hardware. The program may be pre-stored in a storage device such as an HDD or a flash memory of the storage device 200 or pre-stored in a removable storage medium such as a DVD or a CD-ROM. The program may be installed in an HDD or a flash memory of the storage device 200 when the storage medium is mounted in a drive device.

### [First Controller]

The first controller 310 performs, for example, first control (ice spin protection control). The first controller 310 is an example of the first driving force controller. The first controller 310 performs control so that a difference between the rotation speed of the right wheel and the rotation speed of the left wheel is not greater than or equal to a prescribed degree and the speed of the vehicle does not exceed the vehicle speed limit. The first controller 310 calculates a rotation difference between the rotation speed of the right wheel and the rotation speed of the left wheel on the basis of a detection result of the front-side right-wheel speed sensor 110 and a detection result of the front-side left-wheel speed sensor 120. For example, when the calculated rotation difference is greater than or equal to the prescribed degree, the first controller 310 limits the driving force to be applied to the wheels so that the rotation difference is not increased. The first control is, for example, control based on proportional-integral-differential control (PID) control and feed-forward (F/F) control.

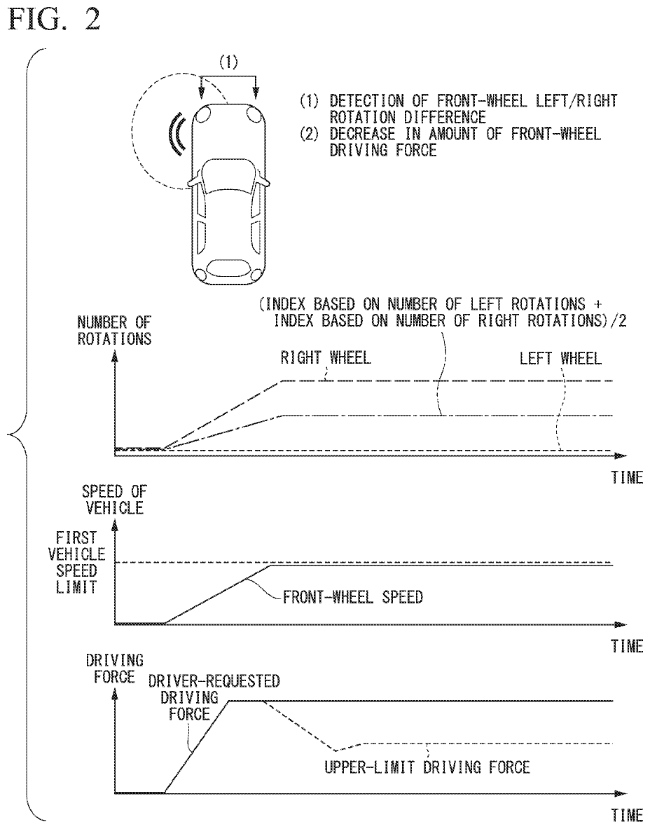

FIG. 2 is an explanatory diagram showing control of the first controller 310. In FIG. 2, the vertical axis represents the number of rotations of the front wheel, a speed of the vehicle, and a driving force and the horizontal axis represents time. In FIG. 2, change lines represent the number of rotations of the right wheel of the front wheels, the number of rotations of the left wheel of the front wheels, a first vehicle speed limit, a speed of the front wheel (a front-wheel speed), a driver-requested driving force, and an upper-limit driving force. The speed of the vehicle is, for example, a value obtained by dividing an index obtained by summing an index based on the number of rotations of the left wheel of the front wheels and an index based on the number of rotations of the right wheel of the front wheels by 2. The index based on the number of rotations is, for example, a speed of the vehicle calculated from the number of rotations.

The first vehicle speed limit is a speed of the vehicle calculated by the first controller 310 on the basis of a preset criterion. For example, the first vehicle speed limit is a speed of the vehicle that is appropriately changed in accordance with a state of the vehicle, road surface conditions (road surface resistance in regions in front of, and to the rear, left and right of the vehicle), and the like. The above-described front-wheel speed is an example of a “speed of the vehicle”. The “speed of the vehicle” is not limited to the front-wheel speed and may be a rear-wheel speed. The first vehicle speed limit may be a speed of the vehicle derived by the first controller 310 on the basis of a preset map and the like.

For example, when the number of rotations of the right wheel increases, a difference between the number of rotations of the right wheel and the number of rotations of the left wheel is greater than or equal to the prescribed degree, and the front-wheel speed has reached the first vehicle speed limit, the first controller 310 limits the driving force of the front wheels so that the front-wheel speed does not exceed the first vehicle speed limit.

### [Second Controller]

The second controller 320 performs, for example, second control (skid protection control). The second controller 320 is an example of the second driving force controller. The second controller 320 controls the driving force to be distributed to the front wheels and the rear wheels so that a difference between the number of rotations of the front wheel and the number of rotations of the rear wheel is not greater than or equal to a prescribed degree. The second controller 320 calculates a rotation difference between the number of rotations of the front wheel and the number of rotations of the rear wheel on the basis of detection results of the front-side right-wheel speed sensor 110, the front-side left-wheel speed sensor 120, the rear-side right-wheel speed sensor 130, and the rear-side left-wheel speed sensor 140.

The number of rotations of the front wheel is, for example, the number of rotations based on the detection results of the front-side right-wheel speed sensor 110 and the front-side left-wheel speed sensor 120 (the average number of rotations between the number of rotations of the right wheel and the number of rotations of the left wheel). The number of rotations of the rear wheel is, for example, the number of rotations based on the detection results of the rear-side right-wheel speed sensor 130 and the rear-side left-wheel speed sensor 140 (the average number of rotations between the number of rotations of the right wheel and the number of rotations of the left wheel). For example, when the calculated rotation difference is greater than or equal to the prescribed degree, the second controller 320 limits the driving force to be applied to the wheels so that the rotation difference is not increased. The second control is, for example, control based on PID control and F/F control.

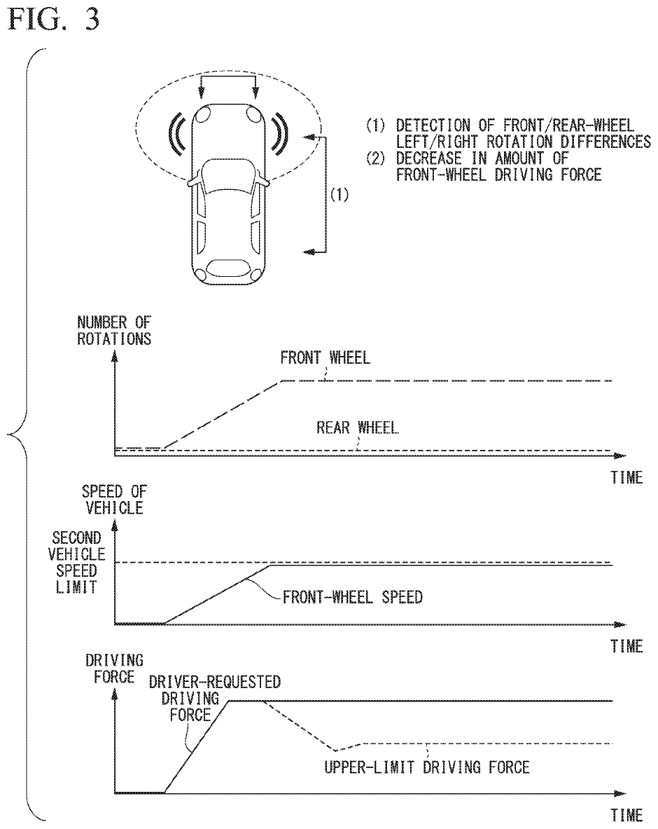

FIG. 3 is an explanatory diagram showing control of the second controller 320. In FIG. 3, the vertical axis represents the number of rotations, a speed of the vehicle, and a driving force and the horizontal axis represents time. In FIG. 3, change lines represent the number of rotations of the front wheel, the number of rotations of the rear wheel, a second vehicle speed limit, a speed based on the rotation of the front wheel (a front-wheel speed), a driver-requested driving force, and an upper-limit driving force. The front-wheel speed is, for example, a value obtained by dividing an index obtained by summing an index based on the number of rotations of the left wheel of the front wheels and an index based on the number of rotations of the right wheel of the front wheels by 2.

The second vehicle speed limit is a limit value of the speed of the vehicle that changes independently of the first vehicle speed limit. The second vehicle speed limit is a speed of the vehicle calculated by the second controller 320 on the basis of a preset criterion. For example, the second vehicle speed limit is a speed of the vehicle that is appropriately changed in accordance with the state of the vehicle and the road surface condition (road surface resistance in front, rear, left, and right regions of the vehicle). The second vehicle speed limit may be a speed of the vehicle derived by the second controller 320 on the basis of a preset map and the like.

For example, when the number of rotations of the front wheel increases, a difference between the number of rotations of the front wheel and the number of rotations of the rear wheel is greater than or equal to a prescribed degree, and a front-wheel speed has reached the second vehicle speed limit, the second controller 320 limits the driving force of the front wheel so that the speed of the front wheel does not exceed the second vehicle speed limit.

The slipping can be minimized by performing the first control or the second control as described above. Furthermore, seizure of a driving force distribution device (a differential) due to poor lubrication is minimized by increasing the rotation difference. The application of torque generated when the traveling road surface changes from a road surface with a low friction coefficient to a road surface with a high friction coefficient to the driving force distribution device is minimized or the application of torque generated at the time of sudden braking in a spin state to the driving force distribution device is minimized.

### [Integrated Controller]

The integrated controller 330 causes either first control or second control to be executed on the basis of the speed of the vehicle, the first vehicle speed limit, and the second vehicle speed limit. For example, the integrated controller 330 compares the speed of the vehicle with the first vehicle speed limit or the second vehicle speed limit to output an instruction for setting the operation state of the first control or the second control to an ON state or an OFF state or determine the control to be executed. Details of the process of the integrated controller 330 will be described below. A function of the integrated controller 330 may be provided in the first controller 310 or the second controller 320. The integrated controller 330 may execute either the first control or the second control by using an “index based on the speed of the vehicle” instead of the “speed of the vehicle”. For example, the integrated controller 330 causes either the first control or the second control to be executed on the basis of the index based on the speed of the vehicle, the first vehicle speed limit, and the second vehicle speed limit. The “index based on the speed of the vehicle” is an index calculated on the basis of the front-wheel speed, the rear-wheel speed, the number of rotations of the wheel of the vehicle, and the like. It is only necessary for the “index based on the speed of the vehicle” to be anything related to the speed of the vehicle such as a value based on the rotation speed of the wheel.

The driving force output device 400 outputs a driving force (torque) for driving the vehicle to the drive wheels. For example, the driving force output device 400 controls the driving force by using a control result of the first controller 310, the second controller 320, or the integrated controller 330. The driving force output device 400 may control a driving force distribution device (not shown) or the like.

### [Specific Example 1]

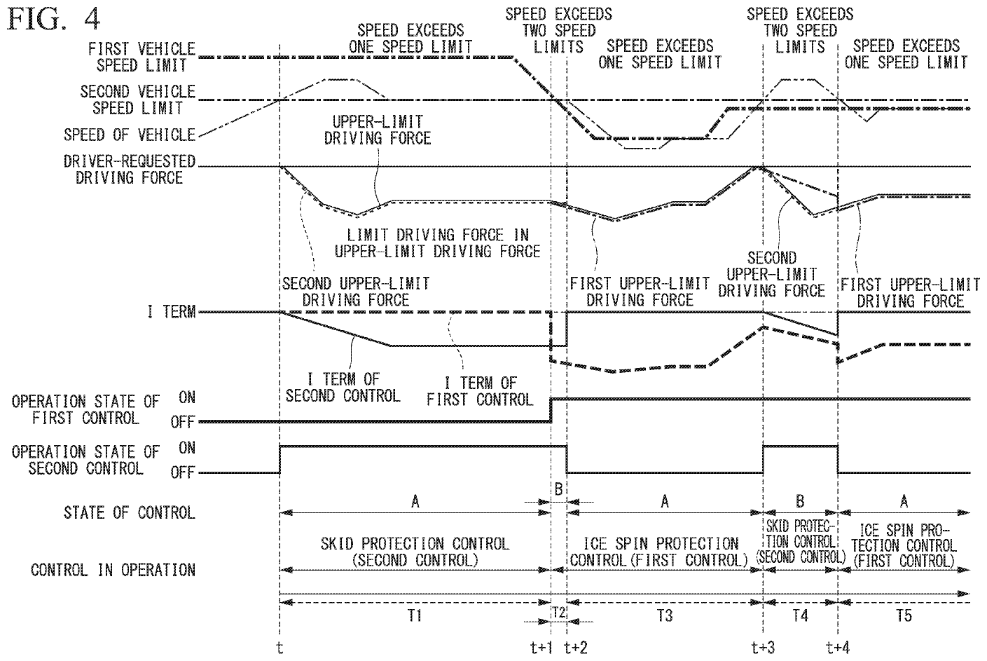

FIG. 4 is an explanatory diagram (part 1) showing details of a process of the integrated controller 330. FIG. 4 is an example of details of control when the vehicle travels on a prescribed road. In FIG. 4, the horizontal axis represents time and the vertical axis represents items corresponding to change lines (a speed of the vehicle, a driving force, a magnitude of an index, and an ON/OFF state).

In FIG. 4, the change line of the first vehicle speed limit, the change line of the second vehicle speed limit, the speed of the vehicle (the front-wheel speed), the change line of the driver-requested driving force, the first upper-limit driving force of the first control, the second upper-limit driving force of the second control, the upper-limit driving force calculated by the integrated controller 330, the change line of the I term in the first control, and the change line of the I term in the second control are shown. In FIG. 4, the operation state of the first control (an ON state or an OFF state), the operation state of the second control (an ON state or an OFF state), the operation states of the first controller 310 and the second controller 320, and control to be executed are shown.

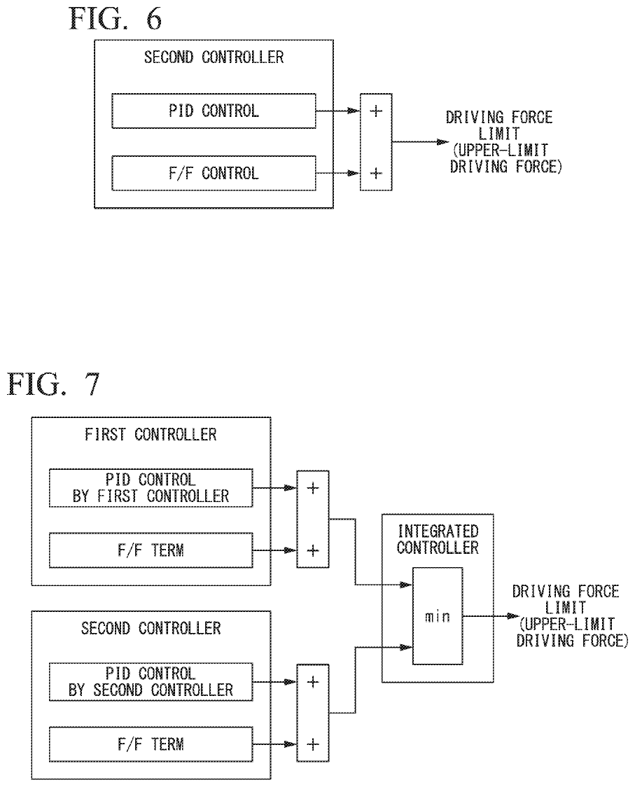

In FIG. 4, for example, it is assumed that the second vehicle speed limit is changed to a constant speed and the first vehicle speed limit is changed to a speed higher than the second vehicle speed limit, changed to a speed lower than the second vehicle speed limit , or changed to a speed similar to the second vehicle speed limit. A period from time t to time t+1 is referred to as a “period T1”, a period from time t+1 to time t+2 is referred to as a “period T2”, a period from time t+2 to time t+3 is referred to as a “period T3”, a period from time t+3 to time t+4 is referred to as a “period T4”, and a period after time t+4 is referred to as a “period T5”. An operation state [A] and an operation state [B] in FIG. 4 will be described with reference to FIGS. 6 and 7 to be described below.

The period T1 is a period in which the front-wheel speed (hereinafter, the speed of the vehicle) exceeds the second vehicle speed limit. In this case, the second controller 320 executes the second control. By performing the second control so that the speed of the vehicle does not exceed the vehicle speed limit, the speed of the vehicle is limited to a speed less than or equal to the second vehicle speed limit of the second control. A value of the I term of the second control is changed to a value which is more negative than a reference value in accordance with an amount by which the speed of the vehicle exceeds the second vehicle speed limit and the speed of the vehicle is changed to approach the second vehicle speed limit. Because the operation state of the first controller 310 is an OFF state, the value of the I term of the second control is set to the reference value.

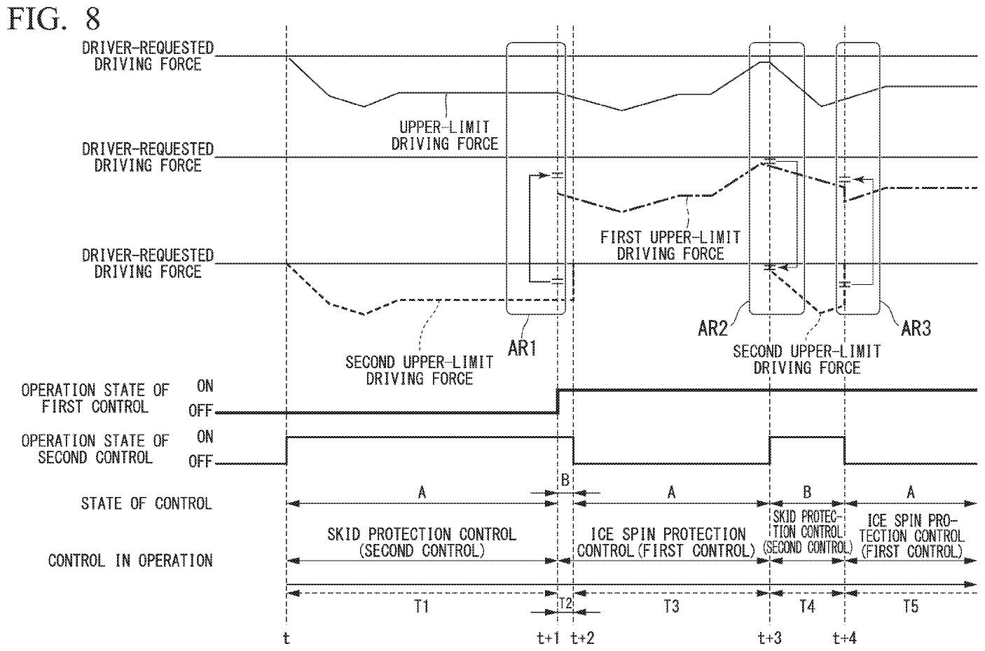

The period T2 is a section in which the first vehicle speed limit is less than the second vehicle speed limit and is a period in which the speed of the vehicle exceeds the first vehicle speed limit and the second vehicle speed limit. The period T2 is a period in which the operation states of the first controller 310 and the second controller 320 are ON states because the speed of the vehicle exceeds the first vehicle speed limit and the second vehicle speed limit. In the period T2, the upper-limit driving force of the first control is smaller than the upper-limit driving force of the second control. In this case, the integrated controller 330 causes the first control to be preferentially executed. By preferentially executing the first control, the speed of the vehicle is limited to a speed less than or equal to the first vehicle speed limit of the first control. When the first control is executed, the initial value of the I term is set for the driving force of the first control so that the upper-limit driving force of the second control operating so far is transferred. Thereby, at the time of the start of the period T2, the I term of the first control starts from a negative value. The transfer of the upper-limit driving force will be described with reference to FIG. 8 to be described below.

The period T3 is a section in which the first vehicle speed limit is lower than the second vehicle speed limit and is a period in which the speed of the vehicle exceeds the first vehicle speed limit in a partial period of the period T3. The period T3 is a section in which the operation state of the first controller 310 is an ON state and the operation state of the second controller 320 is an OFF state because the speed of the vehicle exceeds the first vehicle speed limit. By performing the first control, the speed of the vehicle is limited to a speed less than or equal to the first vehicle speed limit of the first control. A value of the I term of the first control is changed to a value which is more negative than the reference value in accordance with a degree to which the speed of the vehicle exceeds the first vehicle speed limit. At time t+2, the operation state of the second controller 320 is an OFF state and the value of the I term of the second control is reset.

The period T4 is a section in which the first vehicle speed limit is lower than the second vehicle speed limit and is a period in which the speed of the vehicle exceeds the first vehicle speed limit and the second vehicle speed limit. The period T4 is a section in which the first controller 310 and the second controller 320 are in an ON state because the speed of the vehicle exceeds the first vehicle speed limit and the second vehicle speed limit. In the period T4, the upper-limit driving force of the second control is smaller than the upper-limit driving force of the first control. In this case, the integrated controller 330 causes the second control to be preferentially executed. By performing the second control, the speed of the vehicle is limited to a speed less than or equal to the second vehicle speed limit of the second control.

The period T5 is a section in which the first vehicle speed limit is lower than the second vehicle speed limit and is a period in which the speed of the vehicle exceeds the first vehicle speed limit. Similar to the period T3, the period T5 is a section in which the operation state of the first controller 310 is an ON state and the operation state of the second controller 320 is an OFF state because the speed of the vehicle exceeds the first vehicle speed limit. By performing the first control, the speed of the vehicle is limited to a speed less than or equal to the first vehicle speed limit of the first control. The driving force is suppressed to a driving force smaller than the driver-requested driving force.

As described above, control corresponding to a speed exceeding the vehicle speed limit is executed when the speed of the vehicle exceeds one of the first vehicle speed limit and the second vehicle speed limit as shown in FIG. 6 to be described below and a smaller upper-limit driving force between upper-limit driving forces of the first control and the second control is used for control as shown in FIG. 7 to be described below when the speed of the vehicle exceeds both the vehicle speed limits. Thereby, the vehicle can be controlled more accurately in various scenes.

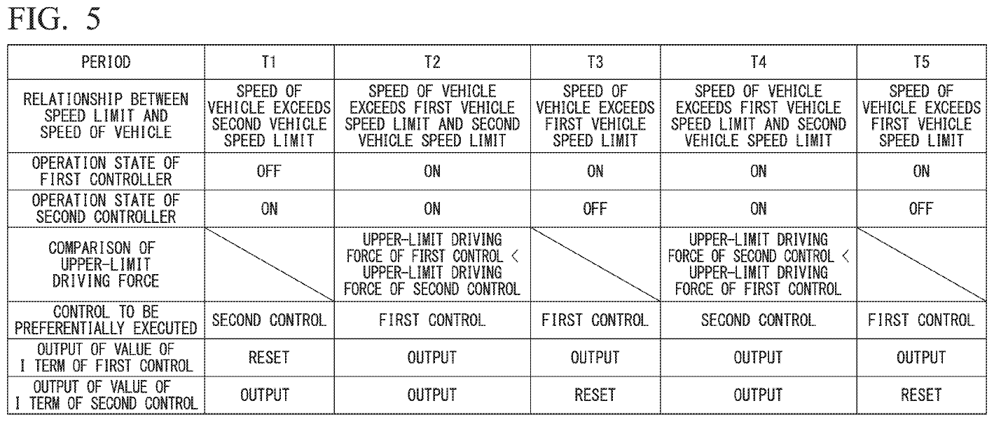

FIG. 5 is a diagram showing a summary of states and the like in the periods T1 to T5 shown in FIG. 4. Here, control in which the I term is integrated will be described. Because the other items are similar to those in the description of FIG. 4 described above, description thereof will be omitted.

In the period T1, because the operation state of the first control is an OFF state and the operation state of the second control is an ON state, the second control is executed, the first control is stopped, a value of an I term is reset, values of a proportional (P) term, a derivative (D) term, and the I term of the second control are output, and the upper-limit driving force is calculated. In the period T2, although the operating states of the first control and the second control are ON states, the values of the P term, the D term, and the I term of the first control are output, and the values of the P term, the D term, and the I term of the second control are output, the first control with a small upper-limit driving force is executed and the upper-limit driving force is calculated.

In the period T3, because the operation state of the first control is an ON state and the operation state of the second control is an OFF state, the first control is executed, the values of the P term, the D term, and the I term of the first control are output, the upper-limit driving force is calculated, and the value of the I term of the second control is reset. In the period T4, although the operating states of the first control and the second control are ON states, the values of the P term, the D term, and the I term of the first control are output, and the values of the P term, the D term, and the I term of the second control are output, the second control is executed and the upper-limit driving force is calculated. In the period T5, because the operation state of the first control is an ON state and the operation state of the second control is an OFF state, the first control is executed, the values of the P term, the D term, and the I term of the first control are output, the upper-limit driving force is calculated, and the value of the I term of the second control is reset.

As described above, when one of the operation of the first controller 310 and the operation of the second controller 320 is in an ON state, the value of the I term of the control that is not in operation is reset. Thereby, even when the control is switched, a rapid increase in the upper-limit driving force is minimized.

As described above, when the operations of both the controllers are in an ON state, an I-term value integration process to be performed by the first controller 310 and the second controller 320 is continued. Thereby, it is possible to transfer an appropriate upper-limit driving force when switching to the driving force control which is not being performed is performed.

FIG. 6 is a diagram showing an example of a process to be performed when the second control is in an ON state. The second controller 320 calculates the upper-limit driving force on the basis of a result of PID control and a result of F/F control. The result of F/F control is, for example, a feed-forward term (an F/F term) calculated by the second controller 320 on the basis of a prescribed model or function, an information table, and the like. The F/F term is set on the basis of, for example, a driving force that becomes a grip limit of the tire of the vehicle 10 or a driving force when the tire starts to slip.

FIG. 7 is a diagram showing an example of a process to be performed when the first control and the second control are in an ON state. The first controller 310 calculates a first upper-limit driving force on the basis of a result of PID control and a result of F/F control. The second controller 320 calculates a second upper-limit driving force on the basis of the result of PID control and the result of F/F control. The integrated controller 330 determines a smaller driving force between the first upper-limit driving force and the second upper-limit driving force as a driving force for use in control.

### [Transfer of Driving Force]

FIG. 8 is an explanatory diagram showing the transfer of a driving force. FIG. 8 is a drawing obtained by extracting details of FIG. 4. The horizontal axis of FIG. 8 represents time and the vertical axis of FIG. 8 represents items (a driving force, a magnitude of an index, and an ON/OFF state) corresponding to respective change lines.

FIG. 8 shows a change line of the driver-requested driving force of FIG. 4, the upper-limit driving force of the first control, the upper-limit driving force of the second control, the upper-limit driving force calculated by the integrated controller 330, and the operating state (an ON or OFF state) of the first control, the operation state (an ON or OFF state) of the second control, the operation states of the first controller 310 and the second controller 320, and control which is being executed.

Time t+1 is a timing at which switching from the second control to the first control is performed. At this timing, the integrated controller 330 sets the I term of the first control so that the initial value of the driving force of the first control is set to a target driving force of the second control when the driving force of the first control is different from the target driving force of the second control as shown in an area AR1 of FIG. 8.

Time t+3 is a timing at which both the first control and the second control are in operation. At this timing, the integrated controller 330 sets the initial value of the I term of the second control so that the initial value of the driving force of the second control is set to a target driving force of the first control when the driving force of the first control is different from the target driving force of the second control as shown in an area AR2 of FIG. 8.

Time t+4 is a timing at which switching from the second control to the first control is performed. At this timing, as shown in an area AR3 of FIG. 8, processing equivalent to processing at the timing of time t+1 is performed.

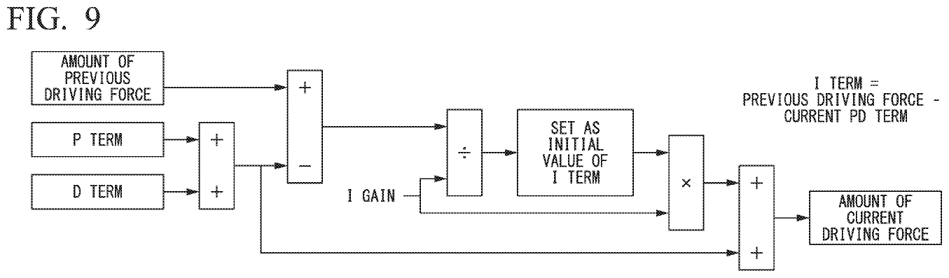

FIG. 9 is a diagram showing an example of a process in which the first controller 310 of a transfer destination calculates a driving force. For example, the first controller 310 subtracts a sum of a value of the P term and a value of the D term from a value of a previous driving force. A value after this subtraction is referred to as a “subtraction value”. The first controller 310 divides the subtraction value by an I gain. A value obtained by the division is set as an initial value of the I term. Then, the first controller 310 multiplies the initial value of the I term by the I gain and further adds a sum of the value of the P term and the value of the D term to a value obtained by the multiplication. A value obtained by the addition corresponds to a current driving force.

As described above, a driving force is controlled so that a gap in the driving force is not generated when switching from one type of control to the other type of control is performed, so that it is possible to prevent an occupant of a vehicle from feeling unease and execute appropriate driving force control to prevent excess or deficiency in the driving force from being caused.

### [Comparative Example]

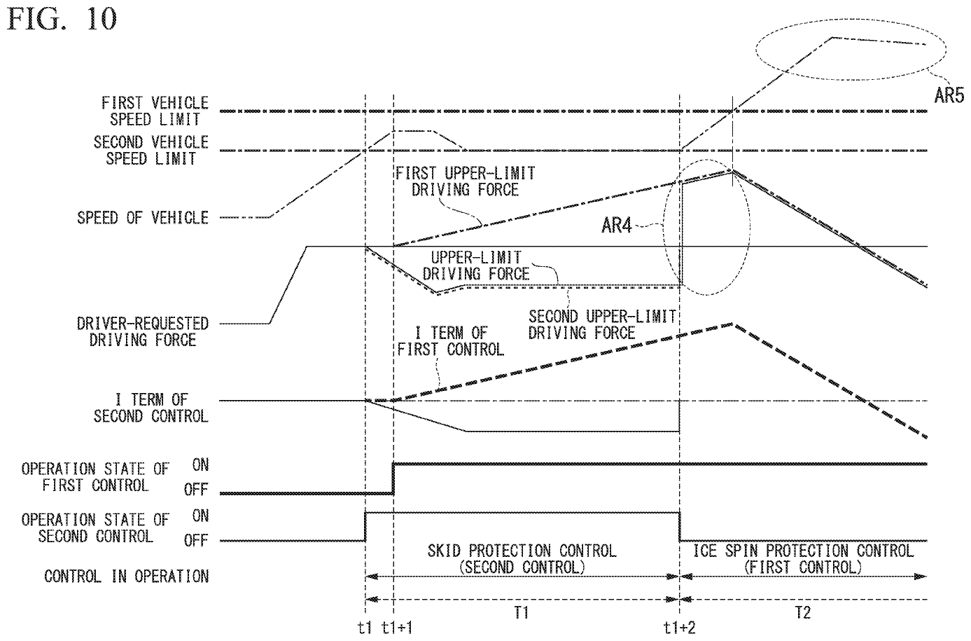

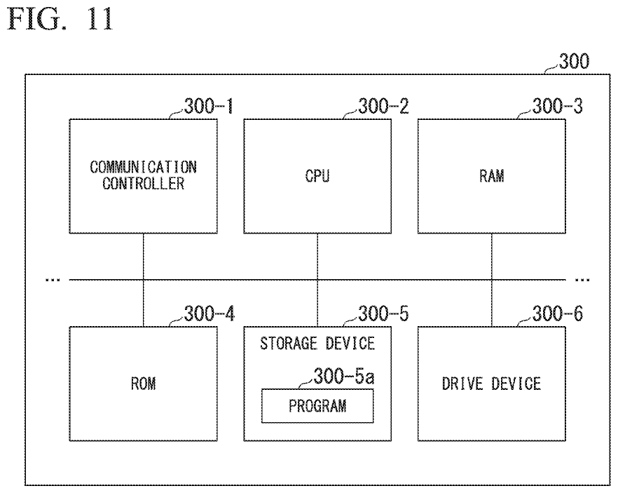

FIG. 10 is a diagram showing an example of details of control by a device of the comparative example. In the device of the comparative example, it is assumed that there are a first controller and a second controller. A case in which the first controller starts an operation, for example, when a speed of a vehicle approaches a first vehicle speed limit, and executes first control when the speed of the vehicle exceeds the first vehicle speed limit and the second controller executes control, for example, when the speed of the vehicle exceeds a second vehicle speed limit, will be described. Starting the operation indicates that PID control is executed and a value of an I term is output.

When the speed of the vehicle is greater than or equal to the second vehicle speed limit at time t1, the second controller executes the second control and calculates an upper-limit driving force. Thereby, the driving force of the vehicle is suppressed to the upper-limit driving force. When the speed of the vehicle approaches the first vehicle speed limit at time t1+1, the first controller starts the operation of the first control and calculates the upper-limit driving force.

A period T1 from time t1+1 to time t1+2 is a period in which the second controller executes the second control. In this period T1, the driving force is suppressed to the upper-limit driving force of the second control that is smaller than the upper-limit driving force of the first control. Thus, in the period T1, because the first controller integrates a value of the I term so that a deviation between the first vehicle speed limit and the speed of the vehicle is compensated for, the upper-limit driving force of the first control increases.

For example, the second control is assumed to be stopped at time t1+2. In this case, the first control is selected. In order to reflect the value of the I term integrated in the period T1 in the control, the first controller causes the upper-limit driving force to rapidly increase at time t1+2 as shown in an area AR4 of FIG. 10. Thereby, the driving force is controlled so that the driving force matches the upper-limit driving force of the first control that has rapidly increased and the speed of the vehicle may overshoot so that the speed of the vehicle exceeds the first vehicle speed limit as shown in an area AR5 of FIG. 10.

As described above, in the device of the comparative example, the upper-limit driving force increases rapidly and the speed of the vehicle overshoots when the control is switched by continuing the integration of the I term.

On the other hand, the control device 300 of the present embodiment controls the integration of the I term, thereby minimizing the rapid increase in the upper-limit driving force and minimizing the overshooting of the speed of the vehicle.

In the device of the comparative example, because the upper-limit driving force rapidly increases and the speed of the vehicle rapidly overshoots, the driver may suddenly step on a brake. Sudden braking may cause excessive torque to be applied to the driving force distribution device (a differential gear). On the other hand, the control device 300 of the present embodiment causes the driver's sudden stepping on the brake to be minimized in order to minimize the rapid increase in the upper-limit driving force and minimize rapid overshooting of the speed of the vehicle. Thus, the control device 300 of the present embodiment can minimize the application of excessive torque to a driving force distribution device compared with a comparative example.

Specifically, the control device 300 can constantly set an appropriate driving force in accordance with a road surface condition and in accordance with a traveling situation and the durability of the differential by changing a vehicle speed limit with two different threshold values of a threshold value based on a left-right rotation difference and a threshold value based on a front-rear rotation difference. Thereby, seizure due to poor lubrication according to differential rotation expansion of the differential is prevented. Because an appropriate driving force can be adjusted by any one type of control, control interference can be prevented and control complexity can be prevented.

According to the above-described embodiment, the control device 300 includes the first controller 310 configured to execute first control for calculating a first vehicle speed limit on the basis of a rotation difference between left and right wheels of a vehicle and calculating an upper-limit driving force according to a speed of the vehicle when the speed of the vehicle exceeds the first vehicle speed limit as a target driving force, the second controller 320 configured to execute second control for calculating a second vehicle speed limit on the basis of a rotation difference between front and rear wheels of the vehicle and calculating an upper-limit driving force according to a speed of the vehicle when the speed of the vehicle exceeds the second vehicle speed limit as a target driving force, wherein the first vehicle speed limit and the second vehicle speed limit change independently of each other, and the integrated controller 330 configured to cause either the first control or the second control to be executed on the basis of the speed of the vehicle, the first vehicle speed limit, and the second vehicle speed limit, so that it is possible to control a vehicle more accurately in various scenes.

### [Hardware Configuration]

For example, the control device 300 of the vehicle system 1 of the above-described embodiment is implemented by a hardware configuration as shown in FIG. 11. FIG. 11 is a diagram showing an example of a hardware configuration of the control device 300 of the embodiment.

The control device 300 has a configuration in which a communication controller 300-1, a CPU 300-2, a random access memory (RAM) 300-3, a read only memory (ROM) 300-4, a storage device 300-5 such as a flash memory or a hard disk drive (HDD), a drive device 300-6, and the like are mutually connected by an internal bus or a dedicated communication line. A portable storage medium such as an optical disk is attached to the drive device 300-6. A program 300-5a stored in the storage device 300-5 is loaded to the RAM 300-3 by a direct memory access (DMA) controller (not shown) or the like and executed by the CPU 300-2, so that the control device 300 is implemented. A program referred to by the CPU 300-2 may be stored in the portable storage medium attached to the drive device 300-6 or may be downloaded from another device via a network NW.

The embodiment described above can be implemented as follows.

A vehicle control system including:

a storage device; and

a hardware processor configured to execute the program stored in the storage device,

wherein the hardware processor executes the program to:

execute first driving force control for calculating a first vehicle speed limit on the basis of a rotation difference between left and right wheels of a vehicle and calculating an upper-limit driving force according to a speed of the vehicle when the speed of the vehicle exceeds the first vehicle speed limit as a target driving force;

execute second driving force control for calculating a second vehicle speed limit on the basis of a rotation difference between front and rear wheels of the vehicle and calculating an upper-limit driving force according to a speed of the vehicle when the speed of the vehicle exceeds the second vehicle speed limit as a target driving force; and

execute either the first driving force control or the second driving force control on the basis of the speed of the vehicle, the first vehicle speed limit, and the second vehicle speed limit,

wherein the first vehicle speed limit and the second vehicle speed limit change independently of each other.

Although modes for carrying out the present invention have been described using embodiments, the present invention is not limited to the embodiments, and various modifications and substitutions can also be made without departing from the scope and spirit of the present invention.

What is claimed is:

1. A vehicle control device comprising:
a first driving force controller configured to execute first driving force control, the first driving force control including calculating a first vehicle speed limit on the basis of a rotation difference between left and right wheels of a vehicle, and calculating a first upper-limit driving force as a target driving force according to a speed of the vehicle when the speed of the vehicle exceeds the first vehicle speed limit; and
a second driving force controller configured to execute second driving force control, the second driving force control including calculating a second vehicle speed limit on the basis of a rotation difference between front and rear wheels of the vehicle and calculating a second upper-limit driving force as a target driving force according to a speed of the vehicle when the speed of the vehicle exceeds the second vehicle speed limit,
wherein the first driving force controller executes the first driving force control or the second driving force controller executes the second driving force control, on the basis of the speed of the vehicle, the first vehicle speed limit, and the second vehicle speed limit, and
wherein the first vehicle speed limit and the second vehicle speed limit change independently of each other.

2. The vehicle control device according to claim 1, wherein,
when the speed of the vehicle exceeds a lower one of the first vehicle speed limit and the second vehicle speed limit, the speed of the vehicle does not exceeds a higher one of the first vehicle speed limit and the second vehicle speed limit, and the lower one is the first vehicle speed limit, the first driving force controller executes the first driving force control,
when the speed of the vehicle exceeds the lower one, the speed of the vehicle does not exceeds the higher one, and the lower one is the second vehicle speed limit, the second driving force controller executes the second driving force control,
when the speed of the vehicle exceeds both of the first vehicle speed limit and the second vehicle speed limit and the first upper-limit driving force is smaller than the second upper-limit driving force, the first driving force controller executes the first driving force control,
when the speed of the vehicle exceeds both of the first vehicle speed limit and the second vehicle speed limit and the second upper-limit driving force is smaller than the first upper-limit driving force, the second driving force controller executes the second driving force control.

3. The vehicle control device according to claim 1,
wherein the first driving force controller executes a first integration process of integrating differences between the first vehicle speed limit and the speed of the vehicle and calculates the first upper-limit driving force by using an integrated value that has been integrated,
wherein the second driving force controller executes a second integration process of integrating differences between the second vehicle speed limit and the speed of the vehicle and calculates the second upper-limit driving force by using an integrated value that has been integrated,
wherein,
when the speed of the vehicle exceeds a lower one of the first vehicle speed limit and the second vehicle speed limit, the speed of the vehicle does not exceeds a higher one of the first vehicle speed limit and the second vehicle speed limit, and the lower one is the first vehicle speed limit, the first driving force controller executes the first driving force control, and the second driving force controller stops the second driving force control and reset the integrated value,
when the speed of the vehicle exceeds the lower one, the speed of the vehicle does not exceeds the higher one, and the lower one is the second vehicle speed limit, the second driving force controller executes the second driving force control, and the first driving force controller stops the first driving force control and reset the integrated value,
when the speed of the vehicle exceeds both of the first vehicle speed limit and the second vehicle speed limit and the first upper-limit driving force is smaller than the second upper-limit driving force, the first driving force controller executes the first driving force control, the first driving force controller continues the first integration process, and the second driving force controller continues the second integration process,
when the speed of the vehicle exceeds both of the first vehicle speed limit and the second vehicle speed limit and the second upper-limit driving force is smaller than the first upper-limit driving force, the second driving force controller executes the second driving force control, the first driving force controller continues the first integration process, and the second driving force controller continues the second integration process.

4. The vehicle control device according to claim 1,
wherein the second driving force controller sets an initial value of a target driving force of the second driving force control to a target driving force of the first driving force control, when the first driving force control is switched to the second driving force control and a driving force of the first driving force control is different from the target driving force of the second driving force control.

5. The vehicle control device according to claim 1,
wherein the first driving force controller sets an initial value of a target driving force of the first driving force control to a target driving force of the second driving force control, when the second driving force control is switched to the first driving force control and a driving force of the second driving force control is different from the target driving force of the first driving force control.

6. A vehicle control method using a control device, comprising:
executing first driving force control, the first driving force control including calculating a first vehicle speed limit on the basis of a rotation difference between left and right wheels of a vehicle and calculating an upper-limit driving force as a target driving force according to a speed of the vehicle when the speed of the vehicle exceeds the first vehicle speed limit;
executing second driving force control, the second driving force control including calculating a second vehicle speed limit on the basis of a rotation difference between front and rear wheels of the vehicle and calculating an upper-limit driving force as a target driving force according to a speed of the vehicle when the speed of the vehicle exceeds the second vehicle speed limit; and
executing either the first driving force control or the second driving force control on the basis of the speed of the vehicle, the first vehicle speed limit, and the second vehicle speed limit,
wherein the first vehicle speed limit and the second vehicle speed limit change independently of each other.

7. A computer-readable non-transitory storage medium storing a program causing a control device to:
execute first driving force control, the first driving force control including calculating a first vehicle speed limit on the basis of a rotation difference between left and right wheels of a vehicle and calculating an upper-limit driving force as a target driving force according to a speed of the vehicle when the speed of the vehicle exceeds the first vehicle speed limit;
execute second driving force control, the second driving force control including calculating a second vehicle speed limit on the basis of a rotation difference between front and rear wheels of the vehicle and calculating an upper-limit driving force as a target driving force according to a speed of the vehicle when the speed of the vehicle exceeds the second vehicle speed limit; and
execute either the first driving force control or the second driving force control on the basis of the speed of the vehicle, the first vehicle speed limit, and the second vehicle speed limit,
wherein the first vehicle speed limit and the second vehicle speed limit change independently of each other.
